(19) United States
(12) Patent Application Publication
(10) Pub. No.: US 2004/0069761 A1
(43) Pub. Date: Apr. 15, 2004

(54) Modular construction for a heating device such as an electric blanket, for enabling connection to alternate sources of power

(76) Inventors: Sheldon P. Carr, West Bend, WI (US); Richard Zimmerer, Charlotte, NC (US)

Correspondence Address: Andrew S. McConnell, Boyle, Fredrickson, Newholm, Stein & Gratz, S.C., Suite 1030, 250 E. Wisconsin Avenue, Milwaukee, WI, 53202, US

(21) Appl. No.: 10/269,592

(22) Filed: Oct. 11, 2002

(51) Int. Cl. H05B 1/00

(52) U.S. Cl. 219/212

(57) ABSTRACT

An electrically operated heating device such as an electric blanket, mattress pad, heating pad or throw, includes a power supply, a controller and a heating member that can be selectively engaged and disengaged with each other, to provide a modular construction. The controller and the power supply can be used with different types of heating members, to provide manufacturing efficiencies and to reduce assembly steps. The controller and the heating member can also be engaged with an adapter which is configured for engagement with a power source associated with a vehicle, such as a cigarette lighter-type power source. In this manner, the pliable heating member and the controller can be used with either a stationary power source or with a power source associated with a vehicle.

### BACKGROUND AND SUMMARY OF THE INVENTION

This invention relates to an electrically operated heating device such as an electric blanket, mattress pad, heating pad or throw, and more particularly to a modular arrangement of components for such a device which provides efficiencies in manufacture and assembly and which enables the device to be used with different types of power supplies.

An electrically operated heating device such as an electric blanket, mattress pad, heating pad or throw, typically includes a pliable member (generically referred to as a blanket portion) which incorporates one or more resistive heating elements interconnected with a power supply. Typically, the various components are secured together in an assembly. In a typical construction, a power supply is adapted to be engaged with a wall outlet and a controller is connected to the power supply. The power supply outputs power through a connector cord or cable to the heating elements associated with the blanket portion. In another typical construction, the blanket portion has a cord with an adapter that is configured to engage a cigarette lighter-type power source associated with a vehicle. The latter construction typically does not include a controller, such that a constant level of heat is generated when power is supplied to the blanket portion from the vehicle power adapter.

It is an object of the present invention to provide an electrically operated heating device, such as an electric blanket, mattress pad, heating pad or throw, which is adapted for use with different types of power supplies, e.g. a power outlet in a building or a vehicle power source. It is a further object of the invention to provide such an electrically operated heating device having a modular construction, in which certain components of the heating device can be used together independent of other components of the device. It is a further object of the invention to provide such an electrically operated heating device having a modular construction and including a controller that can be used with either type of power supply. Yet another object of the invention is to provide such an electrically operated heating device having certain components which can be common to various sizes and/or types of heating members. Yet another object of the invention is to provide such an electrically operated heating device in which the heating device components are easy to manufacture and assemble, and to reconfigure for various uses.

In accordance with the present invention, an electrically operated heating device includes a load, such as a blanket portion, having one or more heating elements. A connector extends from the blanket portion, and is engageable with a power source to establish a path between the power source and the one or more heating elements. The invention contemplates that the power source may be a stationary power source, such as a power source adapted to receive power from a conventional wall outlet, or may be in the form of an adapter for engagement with a power source associated with a vehicle, i.e. a cigarette lighter-type power source. The controller is adapted for use with either type of power source for controlling the output of power to the blanket portion. In a preferred form, the controller controls operation of a switch which controls the supply of power to the blanket portion, to control the heat generated by the blanket portion.

In accordance with another aspect of the invention, a controller and power supply have selectively engageable connections which enable such components to be used in connection with various styles and sizes of heating devices, such as blankets, mattress pads, heating pads or throws. This enables the power supply and controller components to be common across an entire product line, to provide significant manufacturing efficiencies and to reduce the number of parts required to produce a wide range of components.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is an isometric view illustrating an electrically operated heating device, such as an electric blanket, heating pad, throw or the like, incorporating a system for providing power to the heating device from a stationary power supply or from a power supply associated with a vehicle, in accordance with the present invention;

FIG. 2 is a block diagram showing the components incorporated into the stationary power supply for the electrically operated heating device of FIG. 1;

FIG. 3 is a view illustrating the electrically operated heating device of FIG. 1 and the components for supplying power to the heating device from a power source associated with a vehicle; and

FIG. 4 is a circuit diagram showing the components of an adapter incorporated in the power supply system of FIG. 3.

### DETAILED DESCRIPTION OF THE INVENTION

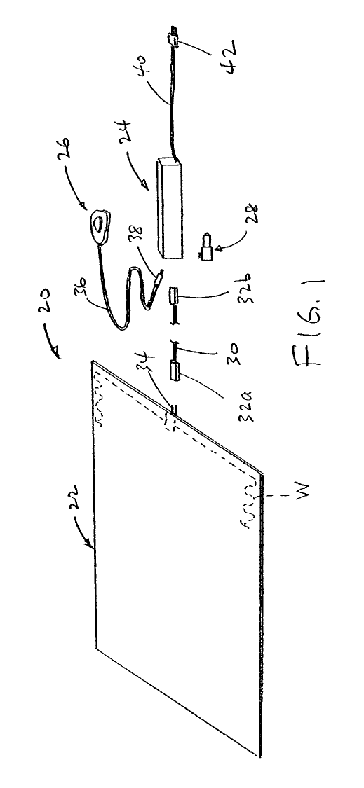

Referring to FIG. 1, an electrically operated heating device, which may be an electric blanket, heating pad or throw shown generally at 20, consists of a pliable member generically designated as a blanket portion 22, a stationary power supply 24, a controller 26, and an adapter 28. Blanket portion 22 includes an embedded heating wire W, which may representatively be configured and arranged within blanket portion 22 as shown and described in co-pending application Ser. No. ______ filed ______ (Attorney Docket No.: 698.002), the disclosure of which is hereby incorporated by reference. A connection cable 30 has a connector 32a at one end and a connector 32b at the opposite end. Connector 32a is adapted for engagement with a power input associated with blanket portion 22, which may representatively include a pair of power input connection prongs 34. Power supply 24 and adapter 28 each include a power output receptacle with which connector 32b is adapted to be engaged, such that cable 30 communicates power from either power supply 24 or adapter 28 to blanket portion 22. Similarly, controller 26 includes a connection cable 36 having a connector 38 at its opposite end. Power supply 24 and adapter 28 each include a control receptacle adapted to receive connector 38 of controller connection cable 36. A power input cord 40 extends from power supply 24, and includes a plug 42 at its end for engagement with a wall outlet or the like, to supply conventional 110 VAC 60 Hz power to power supply 24. Adapter 28 is engageable with a power source associated with a vehicle, e.g. a cigarette lighter, in a manner as is known.

Stationary power supply 24 may representatively have a construction and operation as shown and described in co-pending application Ser. No. ______ filed ______ (Attorney Docket No. 700.001), the disclosure of which is hereby incorporated by reference. Power supply 24 converts the 110 VAC input power from power supply cord 40 into low voltage output power that is supplied to blanket portion 22 through cable 30, as well as to controller 26 through cable 36, for controlling the operation of power supply 24 to control the output of power to blanket portion 22.

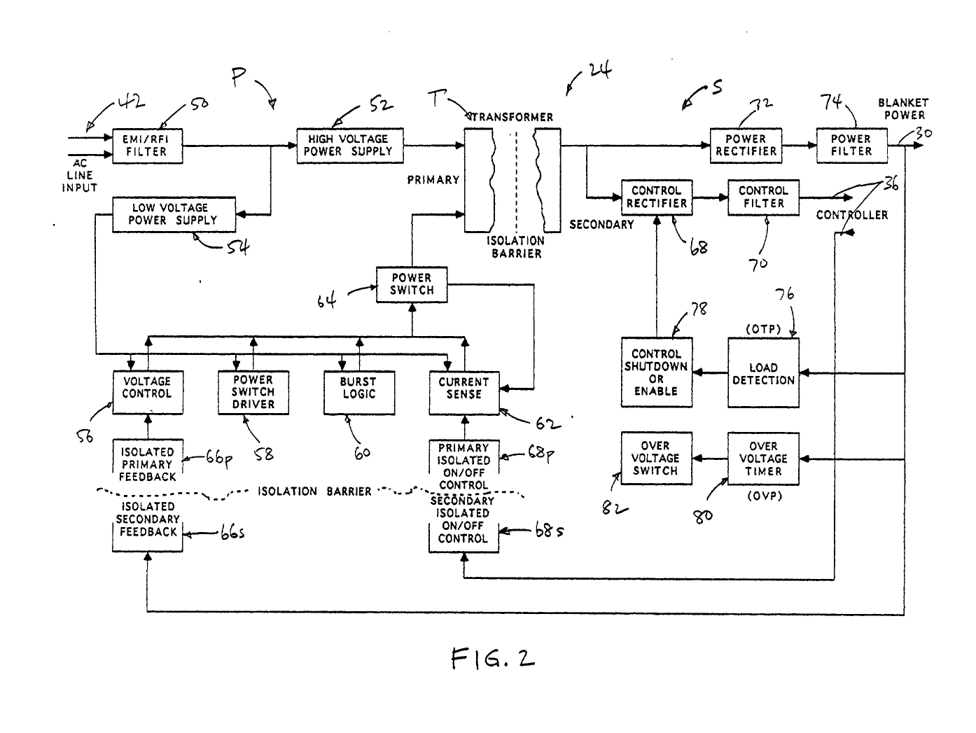

FIG. 2 illustrates in block form the components incorporated in stationary power supply 24. Generally, power supply 24 is divided into a high voltage primary side P and a low voltage secondary side S. High voltage power, such as 110 volt AC power, is supplied to the input of primary side P from electrical cord 42 to an EMI/RFI filter 50, which eliminates conducted and emitted radio frequency interference. From EMI/RFI filter 50, high voltage power is supplied to a high voltage power supply 52, which is connected to the primary side of a transformer T.

In a manner as is known, transformer T has a primary winding that is electrically isolated from a secondary winding, to establish an isolation condition such that voltage generated on the secondary winding is not connected to the primary input line voltage.

Primary side P further includes a low voltage power supply 54 which receives high voltage power from EMI/RFI filter 50, and which is interconnected with the remaining components of primary side P which function to provide selective operation of transformer T to generate low voltage output power for supply to secondary side S. Specifically, low voltage power supply 54 is connected to a voltage control circuit 56, a power switch driver circuit 58, a burst logic circuit 60 and a current sensing circuit 62, all of which provide inputs to a power switch circuit 64 which in turn provides an output to current sensing circuit 62. Power switch circuit 64 is interconnected with the high voltage primary side of transformer T, and functions to control operation of transformer T to generate low voltage power in secondary side S. In addition, primary side P includes an isolated primary feedback 66P and an isolated primary on/off control 68P. Secondary side S includes an isolated secondary feedback 66S that is associated with and isolated from primary feedback 66P, and a secondary isolated on/off control 68S that is associated with and isolated from primary isolated on/off control 68P.

The secondary low voltage side of transformer T provides low voltage output power to the isolated secondary side S of power supply 24. Low voltage power is supplied from the output of transformer T to a low voltage control circuit consisting of a control rectifier 68 and a control filter 70, which in turn provides output power to controller 26 through connector 38 and cable 36. Low voltage power from the output of transformer T is also supplied through a power rectifier 72 and a power filter 74 to blanket portion 22 through blanket portion cable 30 and its associated connector 32.

Low voltage power from power filter 74 is supplied to isolated secondary feedback 66S. Inputs from controller 26 are supplied to secondary isolated on/off control 68S. In addition, secondary side S includes a load detection circuit 76, which in turn is connected to a control shutdown/enable circuit 78 that in turn is interconnected with control rectifier 68. Low voltage output power is also supplied from power filter 74 to an over-voltage timer circuit, which is interconnected with an over-voltage switch circuit 82.

Generally, high voltage power supplied to the high voltage primary side of transformer T is converted by transformer T to low voltage power which is supplied to the secondary side of transformer T, in response to operation of power switch 64. Voltage control circuit 56 acts as a pulse width generating circuit. The feedback control provided by isolated secondary feedback 66S and isolated primary feedback circuit 66P, is operable to provide feedback to modulate the outputs of voltage control circuit 56, which in turn controls the duty cycle of power switch 64 to control the amount of power output to the isolated secondary of transformer T.

Burst logic circuit 60 functions to output a short high level enable logic with a long low logic duty cycle when controller 26 is off. Each short high level enables the power switch 64. The high oscillation override frequency from burst logic circuit 60 functions to store a negligible amount of energy in transformer T, and provides low voltage auxiliary power to controller 26 to enable operation of controller 26 at startup. Controller 26, in turn, provides on/off commands to control the duty cycle of power switch 64.

Current sensing circuit 62 detects the connection of blanket heating cable 30 to the output of transformer T. Current sensing circuit 62 enables a fundamental frequency oscillator of primary side P and disables the higher oscillation frequency output by burst logic circuit 60 when controller 26 is turned on, and latches in an on condition to provide operation of power switch 64 when blanket power wire 30 is plugged in.

Load detection circuit 76 detects when the resistance of blanket portion wires W reach or exceed a predetermined threshold, or when blanket portion 22 is removed by disengagement of cable connector 32 from receptacle 34. When this occurs, load detection circuit 76 shuts down controller 26 to cut off the supply of power to secondary side S as well as heat to blanket wire W. Power cannot be restored until the blanket portion wire W cools and burst logic circuit 60 applies energy to controller 26 as described previously.

It should be understood that the above description of stationary power supply 24 is provided for purposes of illustration, and that any other type of power supply for an electrically operated heating device may be employed.

Stationary power supply 24 is adapted to supply power from a wall outlet or the like to blanket portion 22 when blanket portion 22 is used indoors, typically in a residential environment. Adapter 28 is employed when it is desired to use blanket portion 22 in an environment such as the interior of an automobile, truck or other vehicle having a cigarette light-type power source.

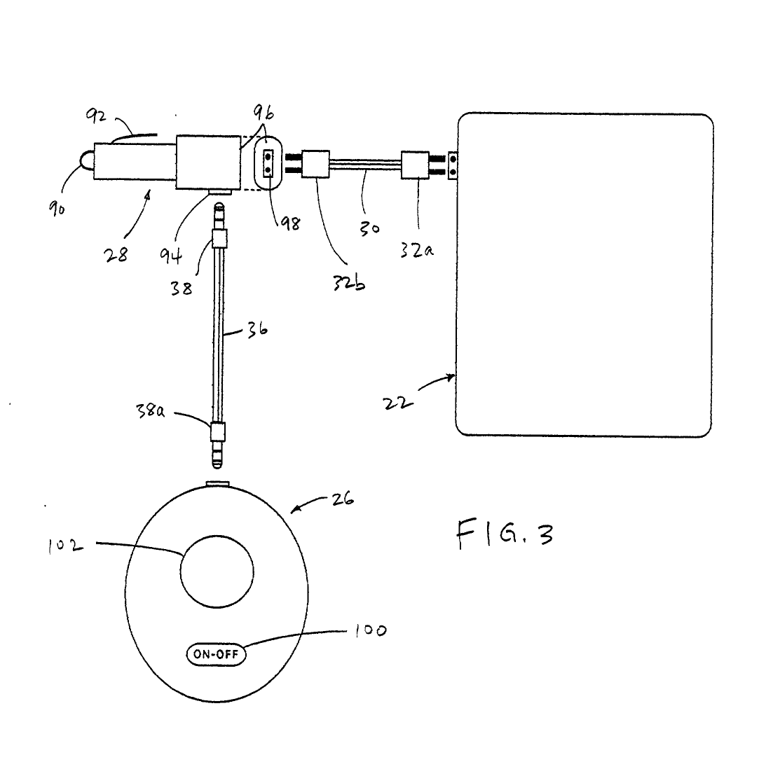

As shown in FIG. 3, adapter 28 includes a housing or body configured for engagement within a receptacle associated with a cigarette lighter-type power source. A tip engagement member 90 and a common engagement member 92 are mounted to the body of adapter 28, to supply power to adapter 28 in a known manner. Adapter 28 further includes a receptacle 94 which is adapted to receive controller cable connector 38. In addition, the opposite end of controller cable 36 may include a connector 38a, such that controller 26 may be selectively engaged with and disengaged from controller cable 36.

In addition, the end of adapter 28 opposite tip engagement member 90, shown at 96, includes a receptacle 98 which is adapted to receive connector 32b at the end of connection cable 30. In FIG. 3, connectors 32a and 32b are illustrated as having outwardly extending prongs and receptacle 98 and the power input of blanket portion 22 are illustrated as having passages adapted to receive the prongs of connectors 32a and 32b. It is understood, however, that any satisfactory type of connection arrangement may be employed to secure connectors 32a and 32b to blanket portion 22 and adapter 28, respectively.

Controller 26 includes an on/off button 100 and an adjustment member 102, which have a construction and operation as illustrated in co-pending application Ser. No. ______ filed ______ (Attorney Docket No. 698.001), the disclosure of which is hereby incorporated by reference.

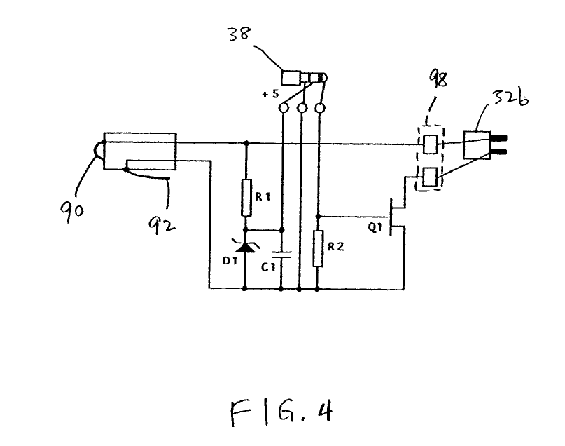

FIG. 4 illustrates the components incorporated in a circuit board contained within the housing of adapter 28. Resistor R1, diode D1 and capacitor C1 convert power from the vehicle power supply (which is typically +12 volt AC power) to +5 volt power to operate controller 26. The +5 volt power from adapter 28 is supplied to controller 26 through controller cable connector 38 and controller cable 36. A control signal is returned from controller 26, which is applied to switch Q1 and resistor R2. When the junction of switch Q1 and resistor R2 is raised to +5 volts, switch Q1 is turned on such that power is applied to blanket portion 22. When switch Q1 is switched off, power to blanket portion 22 is removed. Controlling the on and off cycle of switch Q1 is carried out by means of the circuitry contained within controller 26, to control the amount of heat generated by blanket portion 22 by the cycling properties of the signals output from controller 26. Controller 26 further includes a manual on and off function controlled by on/off button 100 as well as preheat control and a timer shutoff as shown and described in co-pending application Ser. No. ______ filed ______ (Attorney Docket No.: 698.001), the disclosure of which is hereby incorporated by reference.

It can thus be appreciated that heating device 20 has a modular construction which allows blanket portion 22 to be used in connection with a conventional wall outlet for supplying power, or in connection with a vehicle power supply. Blanket portion 22, controller 26 and connector cable 30 are common for both applications, and provide the same advantages in operation in either environment. In addition, the modularity in the components of heating device 20 facilitates manufacture of various types, sizes and styles of heating devices, in that the various components, with or without adapter 28, can be mixed and matched according to the size and/or output of the load, i.e. blanket portion 22.

Various alternatives and embodiments are contemplated as being within the scope of the following claims particularly pointing out and distinctly claiming the subject matter regarded as the invention.

We claim:

1. An electrically operated heating device, comprising:
a first power supply adapted to supply power from a first power source;
a second power supply adapted to supply power from a second power source different than the first power source; and
a connection arrangement for connecting the heating member to either the first power supply or the second power supply so as to enable power to be supplied to the heating member from either power supply.

2. The electrically operated heating device of claim 1, wherein the first power supply is adapted for engagement with a wall outlet and the first power source comprises power supplied to the wall outlet, and wherein the second power supply comprises an adapter for engagement with a vehicle power source and wherein the second power source comprises the electrical system of the vehicle.

3. The electrically operated heating device of claim 2, further comprising a controller adapted for engagement with either the first power supply or the second power supply for controlling the power supplied to the heating member from either power supply.

4. The electrically operated heating device of claim 3, wherein the first and second power supplies each include a first selectively engageable connection area which enables the connection arrangement to connect the heating member thereto, and a second selectively engageable connection area adapted to enable the controller to be engaged thereto.

5. The electrically operated heating device of claim 4, wherein each of the first and second power supplies includes a switch member, and wherein the controller is operable to provide selective actuation of the switch member for controlling the supply of power to the heating member.

6. The electrically operated heating device of claim 5, wherein the controller includes an adjustment member for controlling operation of the switch member so as to vary the power output by the power supply to the heating member.

7. A method of providing power to an electrically operated heating device comprising the steps of:
providing a first power supply having a power output and adapted to supply power from a first power source;
providing a second power supply having a power output and adapted to supply power from a second power source; and
engaging the heating device with the power output of either the first power supply or the second power supply.

8. The method of claim 7, wherein the electrically operated heating device comprises a pliable heating member.

9. The method of claim 8, wherein the step of providing a first power supply is carried out by providing a non-mobile power supply adapted for engagement with a wall outlet, and wherein the step of providing a second power supply is carried out by providing an adapter for engagement with a power source associated with a vehicle.

10. The method of claim 9, further comprising the step of engaging a controller with either the first power supply or the second power supply, wherein the controller is operable to control the power output by either the first power supply or the second power supply to the pliable heating member.

11. The method of claim 10, further comprising the step of adjustably and intermittently switching the supply of power to the pliable heating member on and off via the controller by means of an adjustment arrangement associated with the controller, to vary the power output from either the first power supply or the second power supply to the pliable heating member.

12. A method of producing an electrically operated pliable heating device, comprising the steps of:
providing a power supply having a power output and a controller connection;
providing a controller having a controller connector;
providing a pliable heating device having a power connector; and
engaging the controller connector of the controller with the controller connection of the power supply, and engaging the power connector of the pliable heating device with the power output of the power supply.

13. The method of claim 12, wherein the step of providing a pliable heating device includes the step of selecting the pliable heating device from a plurality of heating devices having different characteristics.

14. The method of claim 12, wherein the step of providing a power supply includes providing a first power supply adapted for engagement with a first power source and providing a second power supply adapted for engagement with a second power source, and wherein the step of engaging the pliable heating device with the power output of the power supply is carried out by engaging the heating device with the power output of either the first power supply or the second power supply.

15. The method of claim 14, wherein the step of engaging the controller is carried out by engaging the controller with the controller connector of either the first power supply or the second power supply.

16. The method of claim 15, further comprising the step of controlling the supply of power to the pliable heating device from either the first power supply or the second power supply by means of an adjustment arrangement associated with the controller.

17. The method of claim 16, wherein the step of controlling the supply of power to the pliable heating device from either the first power supply or the second power supply is carried out by outputting signals from the controller to the power supply that control a switching arrangement associated with the power supply for adjusting the power output to the pliable heating device from the power supply.

18. An electrically operated heating device comprising:
an adapter configured for engagement within a power source associated with a vehicle;
a pliable heating member engaged with the adapter for receiving power therefrom; and
a controller engaged with the adapter for controlling the output of power from the adapter to the pliable heating member to adjust the heat generated by the pliable heating member.

19. The electrically operated heating device of claim 18, wherein the adapter includes a controller connection for providing selective engagement of the controller with the adapter.

20. The electrically operated heating device of claim 19, wherein the adapter further includes a selectively engageable connection arrangement between the pliable heating member and the adapter.

21. The electrically operated heating device of claim 20, further comprising a power supply adapted for engagement with a wall outlet and including a controller connection area and a power output area, wherein the controller is engageable with the controller connection area of the power supply and wherein the pliable heating member is engageable with the power output of the power supply, such that the controller and the pliable heating member can be used with either the power supply or the adapter for supplying power to the pliable heating member from one of two different power sources.
